(19) United States
(12) Patent Application Publication
(10) Pub. No.: US 2019/0102722 A1
(43) Pub. Date: Apr. 4, 2019

(54) SYSTEM AND METHOD ENABLING DYNAMIC TEACHER SUPPORT CAPABILITIES

(71) Applicant: INTERNATIONAL BUSINESS MACHINES CORPORATION, ARMONK, NY (US)

(72) Inventors: MALOLAN CHETLUR, Bangalore (IN); SHAJITH I. MOHAMED, Bangalore (IN); VINAY KUMAR REDDY, BANGALORE (IN); BIKRAM SENGUPTA, BANGALORE (IN); KOMMINIST WELDEMARIAM, Nairobi (KE)

(21) Appl. No.: 15/724,258

(22) Filed: Oct. 3, 2017

(51) Int. Cl. G06Q 10/06; G06Q 50/20; G09B 5/14

(52) U.S. Cl. CPC G06Q 10/06398; G09B 5/14; G06Q 50/20; G06Q 10/06395

(57) ABSTRACT

Systems and methods are provided for monitoring and improving teacher effectiveness. The systems and methods scrutinize various aspects of teacher performance, formulate appropriate recommendations for improving such performance, and provide digital interlinkages among teachers in order to effectively distribute content and improve teacher efficiency.

### BACKGROUND

In embodiments, the technical field of the invention is electronic systems and methods for using such systems for monitoring and improving teacher effectiveness.

Among the many factors influencing student's academic performance, the teacher is one of the most important. Effective teachers could potentially improve even low performing students, whereas ineffective teaching strategies could potentially harm the better performing students. Effective teaching is acquired by experience and/or by training, and a strong social support system for teachers is also an important factor.

Teaching Strategies are tools used towards improving learning outcomes. Strategies can vary with topics, content, student groups and student skill levels, and teachers experience level. Students learning outcomes may vary based on multiple factors such as skill levels, motivation, demography, etc. (individual factors) and student groups, teacher affinity, external environment, etc. (social factors).

Recently there has been a paradigm shift and growing popularity of blended learning systems delivered on handheld devices (e.g. smart phones, tablets). The aim of modern education is allowing instrumentation of user-interactions with rich multi-media learning content and sophisticated interfaces, collect fine-grained data, etc.

Currently teachers are expected to perform various labor-intensive activities such as teach classes, plan lessons, conduct quiz, test assessment, etc., monitor attendance and behavior, intervene with poor performing students, conduct parent counseling for multiple student groups of multiple grades and varying skill levels. Simultaneously, teachers are expected to improve the learning outcomes of all students by themselves. This includes devising learning strategies and activities based on their intuition and experience. However, teachers do not have end to end toolchain to support, advise, recommend and manage their teaching to improve learning outcomes of their students

Classes, subjects, learning tools, strategies are given to teachers without any automated support and context, and mostly using ad-hoc support systems, which are not effective, scalable and sustainable.

In emerging markets characterized by resource-constrained environment, further unique sets of problems due to: Student to Teacher ratios are very high (above 40 students); shortage of trained teachers, most of the teachers are beginners and who learn on the job; and existing teacher support systems mostly focus on policy formulation, even often done without involving the teachers.

Furthermore, so many teacher resources exist that it is hard for teachers to wade through the plethora of information or connect with experts to get help for their teaching needs on time. There is a need for intelligent dynamic support in real time to connect with peer teachers, experts (including automated expert system) and other resources (on time) towards improved teaching and learning outcomes.

### SUMMARY

In aspects, the invention provides a dynamic online and offline Teacher Support System (TSS) for effective teaching and learning outcomes, using various affinity measures within a teacher (social) network. The invention also provides dynamic online and offline notification of availability of teaching support by an intelligent module within the teacher network towards lectures, notes, assignments and other teaching artefacts. Online and Offline collaboration of teachers is based on various effectiveness measures. Dynamic and real-time connection of teachers and teaching resources to teachers is provided through the teacher support system. The TSS provides evidence based (data driven) determination of various teacher effectiveness measures. Teacher effectiveness measures are used to automatically determine content, teaching strategy and teaching plan for teachers.

In an aspect, then, is a teacher support system comprising: a measurement component configured to automatically determine a teacher effectiveness index for a teacher in a context, the context comprising observation data and student performance data; a matching component configured to automatically determine an intervention based at least on the teacher effectiveness index, the intervention suitable to assist the teacher and improve the teacher effectiveness index for the teacher; a networking component configured to automatically identify a human resource based at least on the teacher effectiveness index, the human resource suitable to assist the teacher and improve the teacher effectiveness index for the teacher; a feedback component configured to automatically generate an output based at least on the teacher effectiveness index, the output configured to alter a user interface to identify to the teacher the intervention and the human resource. In embodiments:

the teacher effectiveness index for the teacher is determined based on observation data selected from a teacher-student affinity measure, a teacher-content effectiveness measure, a teaching strategy content effectiveness measure, a topical content effective measure, and combinations thereof;

the system comprises a sensor configured to record the observation data, the sensor selected from: a stand-alone sensor located in a classroom and positioned to monitor a student behavior and an interaction between the teacher and the student; a sensor disposed in an interactive device configured for use by the student; and combinations thereof;

the system comprises one or more sensors (e.g., 2, 3, 4, 5, 10, or more than 10 sensors) configured to record the observation data, the sensors selected from: a stand-alone sensor located in a classroom and positioned to monitor a student behavior and an interaction between the teacher and the student; a sensor disposed in an interactive device configured for use by the student; and combinations thereof;

the teacher effectiveness index for the teacher is determined based on student performance data obtained from an interactive device configured for use by a student;

the intervention comprises an action selected from revision of teaching content, revision of teaching strategy, adoption of a teaching activity, consultation with a mentor (via, e.g., the IBM® cognitive teacher advisor system such as conversational gent or chatbot), digitally sharing a lesson plan, digitally sharing a teaching strategy, enrolment in a professional development course, revision of a teaching assignment, and invitation of a co-teacher;

the intervention comprises an action selected from revision of teaching content, revision of teaching strategy, adoption of a teaching activity, consultation with a mentor (via a cognitive teacher advisor system), digitally sharing a lesson plan, digitally sharing a teaching strategy, enrolment in a professional development course, revision of a teaching assignment, and invitation of a co-teacher;

the intervention comprises a suggested lesson plan received from a teacher network;

the intervention comprises a suggested lesson plan received from a teacher network along with a suggested teaching strategy suitable for the lesson plan;

the matching component is configured to retrieve historical student data and to use the historical student data in determination of the intervention;

the human resource is a complementary teacher in a virtual teacher network or a professional development specialist;

the human resource can be a virtual assistance configured with interactive device and software program (e.g., educational conversational agent or chatbot);

the observation data are collected from a plurality of sensors, the plurality of sensors comprising at least a body camera (i.e. camera fixed to the body of the teacher) and fixed point camera configured to observe a teacher-student interaction, and wherein the student performance data are collected by an application disposed on an interactive device selected from a tablet, desktop computer, and laptop computer;

the output is a report and the feedback component automatically transmits the report electronically to an address associated with the teacher, the report comprising data obtained by the measurement component and the intervention determined by the matching component;

the teacher effectiveness index for the teacher is determined based on observation data selected from a teacher-student affinity measure, a teacher-content effectiveness measure, a teaching strategy content effectiveness measure, a topical content effective measure, and combinations thereof, and the teacher effectiveness index for the teacher is determined based on student performance data obtained from an interactive device configured for use by a student;

the teacher effectiveness index for the teacher is determined based on observation data selected from a teacher-student affinity measure, a teacher-content effectiveness measure, a teaching strategy content effectiveness measure, a topical content effective measure, and combinations thereof, and the intervention comprises an action selected from revision of teaching content, revision of teaching strategy, adoption of a teaching activity, consultation with a mentor (via a cognitive teacher advisor system), digitally sharing a lesson plan, digitally sharing a teaching strategy, enrolment in a professional development course, revision of a teaching assignment, and invitation of a co-teacher;

the output is a report and the feedback component automatically transmits the report electronically to an address associated with the teacher, the report comprising data obtained by the measurement component and the intervention determined by the matching component, and the intervention comprises a suggested lesson plan received from a teacher network; and

the intervention comprises an action selected from revision of teaching content, revision of teaching strategy, adoption of a teaching activity, consultation with a mentor (via a cognitive teacher advisor system), digitally sharing a lesson plan, digitally sharing a teaching strategy, enrolment in a professional development course, revision of a teaching assignment, and invitation of a co-teacher, and the output is a report and the feedback component automatically transmits the report electronically to an address associated with the teacher, the report comprising data obtained by the measurement component and the intervention determined by the matching component.

In another aspect is a method for improving teacher efficiency, the method comprising: determining a teacher effectiveness index for a teacher in a context; determining an intervention for the teacher suitable for improving the teacher effectiveness index for the teacher in the context, the intervention based on the determined teacher effectiveness index and the context; digitally interlinking the teacher with one or more complementary teachers in a virtual teacher network, (the one or more complementary teachers selected based on the intervention and the context); digitally interlinking the teacher with one or more complementary interactive device and software program (e.g., educational conversational agent or chatbot) in a virtual teacher network; and communicating to the teacher the determined intervention and one or more identities corresponding to the one or more complementary teachers. In embodiments:

the selection of the one or more complementary teachers, software program and interactive device is based on various factors, including: the teacher profile (e.g., experience level) and cohort, intervention type and the context;

the context comprises factors selected from topic, content, grade level, student demographics, student group, and teacher strategy;

the teacher effectiveness index combines measures selected from student-teacher affinity measure, teacher-content effectiveness measure, content-teaching strategy effectiveness measure, topic-content effectiveness measure, and topic-teaching plan effectiveness measure;

the teacher effectiveness index is determined using data collected by one or more stand-alone sensors configured to observe the teacher and one or more devices configured for use by a student;

the intervention comprises an action selected from revision of teaching content, revision of teaching strategy, adoption of a teaching activity, consultation with a mentor, digitally sharing a lesson plan, digitally sharing a teaching strategy, enrolment in a professional development course, revision of a teaching assignment, and invitation of a co-teacher;

the teacher effectiveness index is determined by an algorithm, and wherein the algorithm is periodically updated based on pooled effectiveness data;

the teacher effectiveness index is determined by an algorithm, and wherein the algorithm is periodically updated based on analysis of pooled effectiveness data;

further comprising collecting effectiveness data after communicating to the teacher and revising the teacher effectiveness index based on the collected effectiveness data;

the communicating to the teacher comprises modifying a user interface on a device used by the teacher, electronically sending a message to the one or more complementary teachers, or modifying a user interface on a device used by a student, or combinations thereof; and

further comprising aggregating teacher effectiveness indices from a plurality of teachers and optimizing teacher assignments based on the aggregated indices.

In an aspect is a system for carrying out the method as above, the system comprising: a measurement component configured to automatically estimate the teacher effectiveness index; a matching component configured to automatically determine the intervention; a networking component configured to automatically interlink the teacher to the one or more complementary teachers in the teacher network; and a communicating component configured to automatically communicate to the teacher the determined intervention and the one or more complementary teachers.

In an aspect is a method for improving teacher efficiency, the method comprising: automatically estimating a Teacher Effectiveness Index based on: observation data selected from: Teacher—Student Affinity Measure; Teacher—Content Effectiveness Measure; Teaching Strategy—Content Effectiveness Measure; and Topic—Content Effectiveness Measure; student/teacher data selected from: comparison with overall distribution of historical performance data; Comparison with historical data with respect to group of student; Comparison with historical data with respect to a single student; Estimated teaching effectiveness towards a course or group of students; and Estimated individual student-teacher affinity; automatically communicating a recommendation to a teacher, the recommendation comprising: selected specific teaching content for a teacher to group of students; selected effective teaching strategies for topics/content for a group of students; selected teaching plan for topics/contents for teachers to group of students; and optimal assignment of teachers to classes/courses/training programs given constraints of limited classes, courses and training programs; and automatically connecting the teacher to teacher resources in real-time or in offline mode.

In an aspect is a method to automatically estimate Teacher Effectiveness Measures based on observed data, including: Teacher—Student Affinity Measure; Teacher—Content Effectiveness Measure; Teaching Strategy—Content Effectiveness Measure; and Topic—Content Effectiveness Measure.

In an aspect is a method to estimate teacher effectiveness measures from the students/teachers data based on any of the following or in combination: comparison with overall distribution of historical performance data; comparison with historical data with respect to group of student; comparison with historical data with respect to a single student; estimating teaching effectiveness towards a course or group of students; and estimating individual student-teacher affinity.

In an aspect is a method for improving teacher efficiency, the method comprising: recording observation data of a teacher using at least one sensor positioned to observe, in-situ, a student behavior and an interaction between the teacher and the student; determining a teacher effectiveness index for the teacher in a context, the context comprising the observation data; determining an intervention for the teacher suitable for improving the teacher effectiveness index for the teacher in the context, wherein the intervention is based at least in part on the determined teacher effectiveness index and the context, and wherein the intervention comprises at least one item selected from: an online identity corresponding to a complementary teacher in a virtual teacher network; an access enabler to an online teacher training software; and a digital teaching aid; and communicating a message comprising the determined intervention to a user account corresponding to the teacher.

In an aspect is a method for improving teacher efficiency, the method comprising: recording observation data of a teacher using at least one sensor positioned to observe, in-situ, a student behavior and an interaction between the teacher and the student; determining a teacher effectiveness index for the teacher in a context, the context comprising the observation data; determining an intervention for the teacher suitable for improving the teacher effectiveness index for the teacher in the context, wherein the intervention is based at least in part on the determined teacher effectiveness index and the context, and wherein the intervention comprises at least one item selected from: an online identity corresponding to a complementary teacher in a virtual teacher network; an access enabler to an online teacher training software; and a digital teaching aid; composing a message comprising the determined intervention, wherein the message is personalized to the teacher or is suitable for a teacher group to which the teacher is assigned; and configuring a communication channel to deliver the composed message to a user account associated with the teacher or to a group of user accounts associated with the teacher group to which the teacher is assigned. In embodiments:

after communicating the message (also referred to herein as a notification), the method further comprises: recording follow-up observation data of the teacher using the at least one sensor; determining a follow-up teacher effectiveness index using the follow-up observation data; and communicating, to the user account corresponding to the teacher, a message comprising the follow-up teacher effectiveness index;

the communications channel is selected from text, audio, video messaging channel, or combinations thereof;

the method further comprises communicating the message via the communication channel to the user account associated with the teacher or to the group of user accounts associated with the teacher group to which the teacher is assigned;

the context further comprises factors selected from topic, content, grade level, student demographics, student group, and teacher strategy;

the teacher effectiveness index combines measures selected from student-teacher affinity measure, teacher-content effectiveness measure, content-teaching strategy effectiveness measure, topic-content effectiveness measure, and topic-teaching plan effectiveness measure;

the teacher effectiveness index is further determined using data collected by one or more devices configured for use by a student;

the teacher effectiveness index is determined by an algorithm, and wherein the algorithm is periodically updated based on analysis of pooled effectiveness data;

the online identity enables the teacher to communicate with the complementary teacher using the virtual teacher network, wherein the complementary teacher is selected from a mentor teacher and a potential co-teacher; the access enabler is a digital link or a passcode enabling the teacher to access the teacher training software; and the digital teaching aid comprises: a recommendation for revision of a teaching strategy, teaching content, or lesson plan; a model lesson plan or model teaching strategy; a recommendation for adoption of a teaching activity; and a recommendation for enrolment in a professional development course;

the communicating to the user account corresponding to the teacher comprises modifying a user interface on a device used by the teacher, electronically sending a message to user accounts corresponding to one or more complementary teachers, or modifying a user interface on a device used by a student, or a combination thereof; and

further comprising aggregating teacher effectiveness indices from a plurality of teachers and optimizing teacher assignments based on the aggregated indices.

In an aspect is a system for carrying out the method as above, the system comprising: a sensor for recording observation data; a measurement component configured to automatically estimate the teacher effectiveness index based on the observation data; a matching component configured to automatically determine the intervention; a communicating component configured to automatically communicate to the teacher the determined intervention; and a GUI component configured to automatically modify a display of a user device to display at least a portion of the determined intervention. In embodiments the GUI component includes a conversation agent terminal. In embodiments the user device is a mobile device or any other device as described herein.

In an aspect is a teacher support system comprising: at least one sensor positioned to observe, in-situ, observation data of a student behavior and an interaction between a teacher and the student, the at least one sensor configured to communicate the observation data via a distributed network; and a server configured to receive the observation data via the distributed network, the server comprising: a processor coupled to a memory; a measurement component configured to automatically determine a teacher effectiveness index for a teacher in a context, the context comprising the observation data and, optionally, student performance data; a matching component configured to automatically determine an intervention based at least on the teacher effectiveness index, the intervention suitable to assist the teacher and improve the teacher effectiveness index for the teacher; a networking component configured to automatically identify a human resource based at least on the teacher effectiveness index, the human resource suitable to assist the teacher and improve the teacher effectiveness index for the teacher; and a feedback component configured to automatically generate an output based at least on the teacher effectiveness index, the output configured to alter a user interface to identify to the teacher the intervention and the human resource. In embodiments:

the teacher effectiveness index for the teacher is determined based on observation data selected from a teacher-student affinity measure, a teacher-content effectiveness measure, a teaching strategy content effectiveness measure, a topical content effective measure, and combinations thereof;

further comprising a feedback control component configured, upon reception of signals from one or more analytics engines, to retrieve feedbacks from system-generated pools and to dynamically update one or more corresponding teacher-network graph;

the at least one sensor is selected from: a stand-alone sensor located in a classroom and positioned to monitor a student behavior and an interaction between the teacher and the student; a sensor disposed in an interactive device configured for use by the student; and combinations thereof;

the teacher effectiveness index for the teacher is further determined based on student performance data obtained from an interactive device configured for use by a student;

the intervention comprises an action selected from revision of teaching content, revision of teaching strategy, adoption of a teaching activity, consultation with a mentor, digitally sharing a lesson plan, digitally sharing a teaching strategy, enrolment in a professional development course, revision of a teaching assignment, and invitation of a co-teacher;

the intervention comprises a suggested lesson plan received from a teacher network along with a suggested teaching strategy suitable for the lesson plan;

the human resource is a complementary teacher in a virtual teacher network or a professional development specialist;

the human resource can be a virtual assistance configured with interactive device and software program; and

the observation data are collected from a plurality of sensors, the plurality of sensors comprising at least a body camera and fixed point camera configured to observe a teacher-student interaction, and wherein the student performance data are collected by an application disposed on an interactive device selected from a tablet, desktop computer, and laptop computer.

In an aspect is a method to automatically deliver various recommendations to teachers, comprising: selecting specific teaching content for a teacher to a group of students; selecting effective teaching strategies for topics/content for a group of students; selecting teaching plan for topics/contents for teachers to group of students; and/or optimal assignment of teachers to classes/courses/training programs given constraints of limited classes, courses and training programs.

In an aspect is a method for improving teacher efficiency, the method comprising: automatically estimating a Teacher Effectiveness Index based on: observation data selected from: Teacher—Student Affinity Measure; Teacher—Content Effectiveness Measure; Teaching Strategy—Content Effectiveness Measure; and Topic—Content Effectiveness Measure; student/teacher data selected from: comparison with overall distribution of historical performance data; Comparison with historical data with respect to group of student; Comparison with historical data with respect to a single student; Estimated teaching effectiveness towards a course or group of students; and Estimated individual student-teacher affinity; automatically communicating a recommendation to a teacher, the recommendation comprising: selected specific teaching content for a teacher to group of students; selected effective teaching strategies for topics/content for a group of students; selected teaching plan for topics/contents for teachers to group of students; and optimal assignment of teachers to classes/courses/training programs given constraints of limited classes, courses and training programs; and automatically connecting the teacher to teacher resources in real-time or in offline mode.

In an aspect is a method to automatically connect teachers and teacher resources in real-time or in offline mode.

These and other aspects of the invention will be apparent to one of skill in the art from the description provided herein, including the examples and claims.

### BRIEF DESCRIPTION OF THE DRAWINGS

FIG. 1 provides an example architecture for the Teacher Support System (TSS) and components thereof according to an embodiment of the invention.

FIG. 2 provides an example flow chart for data and output from the TSS according to an embodiment of the invention.

FIG. 3 provides an alternative example flow chart for data and output from the TSS according to an embodiment of the invention.

FIGS. 4A-4C (collectively, FIG. 4) provide schematic data showing effective teachers versus relatively ineffective teachers in a contextual setting for a specific topic or course.

FIGS. 5A-5B (collectively, FIG. 5) provides schematic data showing effective teachers versus relatively ineffective teachers in a contextual setting across a variety of topics or courses.

FIG. 6 provides an example graphical user interface showing selected features according to an embodiment of the invention.

### DETAILED DESCRIPTION

Throughout this disclosure, unless indicated otherwise or clear from the context, the term “offline” is meant to refer to interaction outside the class and non-face-to-face interactions between students and teachers, whereas the term “online” is meant to refer to interaction within a class and face-to-face between students and teachers.

The Dynamic Online and Offline Teacher Support System (TSS) include a measurement component, matching (analytics) component, a teacher network services component, and a feedback and control system component. Details of these components are provided herein.

### Measurement Component

The measurement component is configured to automatically determine a teacher effectiveness index for a teacher in a context.

In embodiments, the measurement component determines teacher effectiveness (i.e., the teacher effectiveness index) with respect to contextual factors that include topic, content, student, student group, and teaching strategy, and performance/behaviour of the student among students with content from the same topic. The measurement component also measures affinity between a teacher and a student or group of students, wherein the students may be grouped based on demography, skills, interest, and/or the like. The component further determines teaching strategy adopted by teachers for a particular content or topic (Content—Teaching Strategy Effectiveness Measure), and measures effectiveness of the content on a specific topic observed from student's performance. The component further measures learning activities by topic prescribed by teachers (Topic—Teaching/Intervention Plan Effectiveness).

The measurement component uses data from various sources to carry out the various functions. Observation data can be used, and refers to data obtained from sensors or the like pertaining to actual activities by students, teachers, and other entities in the classroom environment. This may be referred to herein as data collected in-situ. Student performance data can also be used, and refers to historical and real-time data pertaining to actual student performance on exams, quizzes, assessments, assignments (in class or out of class), group projects, projects, or the like. Student performance data can be from marked activities or un-marked activities, and can be extrapolated data based on a subset of performance data. Marked data includes data that is marked automatically (e.g., via digital methods such as scanning) as well as manually.

Data (i.e., observation data) used by the measurement component can be obtained by any suitable number and variety of sensors and data collection methods. Sensors include those configured for sensing visual (e.g., cameras, etc.), heat, audio, movement, or the like as input, as well as any combination thereof. Sensors may be positioned in fixed locations within a classroom, or may be mobile such as a sensor worn on the body of a teacher or student. In embodiments the system collects data from 1, 2, 3, 4, 5, or more than 5 sensors. Other data collection methods are also suitable for gathering data, such as collecting digital data from devices positioned in the classroom, used by students, or used by teachers, or a combination thereof. Such data may include observations of student actions and interactions, student input such as writings or oral recordings, or the like. Data may be collected over a period of time, such as over 1, 2, 3 or more than three hours, or such as over 1, 2, 3, or more than 3 days. Data collection may be continuous or periodic as desired. The goal of such data collection, in embodiments, is to obtain an understanding of the interaction between student(s) and teacher, and to help the measurement component to calculate the teacher effectiveness index, including by recording aspects of the context that help define and explain the teacher effectiveness index.

The teacher effectiveness index is a measure of the effectiveness of a teacher in a specific situation/context, and may be determined from (or influenced by) a variety of data such as teacher effectiveness measures and other measures. A teacher effectiveness measure is data that measures the effectiveness of a teacher in a context and with respect to a specific activity, such as with respect to topic, content, student, student group and teaching strategy. Further data includes a student-teacher affinity measure. This is a measure of the affinity between a teacher and a student or group of students, wherein the students may be grouped based on demography, skills, interest etc. Further data includes a teacher-content effectiveness measure, which is the effectiveness of a teacher among her/his student(s) with contents from the same topic. Further data includes a content-teaching strategy effectiveness measure, which measures the effectiveness of teaching strategy adopted by teachers for the content or topic. Further data includes a topic-content effectiveness measure, which measures the effectiveness of content on a specific topic observed from student's performance. Further data includes a topic-teaching/intervention plan effectiveness measure, which measures the effectiveness of learning activities for topic prescribed by teachers. All such data may be based either on data collected by sensors or other data collection means, or on performance data, or extrapolations thereof, or interpretations thereof, or combinations thereof.

The teacher effectiveness index is calculated from the data described above plus any other relevant and desirable data that is available pertaining to the context. An example of the algorithm to calculate the index is

teacher effectiveness measure=F(teacher effectiveness measure,student-teacher affinity measure,teacher-content effectiveness measure,content-teaching strategy effectiveness measure,topic-content effectiveness measure,topic-teaching/intervention plan effectiveness measure)

where F(.) represents a generic function of its arguments, i.e., variables. One instance of F(.) is a linear function, i.e., teacher effectiveness index=Σwᵢ*mᵢ, where wᵢ corresponds to the weighing factor for each measure mᵢ as listed in the above equation. Weighting factors indicate the importance of each variable towards index computation. In a simple case, values of each of these weighing factors could be fixed uniformly as

$$\frac{1}{number\_of \_variables} .$$

Alternatively, it could be estimated in a data driven manner from a sample training data set or could be fixed based on importance assigned to each variable by the domain experts. Teacher effectiveness measure is computed consistently across teachers, students, subjects, and other contextual aspects. The possible teacher effectiveness index values and ranges will vary depending on the function and parameters used to compute it.

The teacher effectiveness index allows an estimation of the effectiveness of the teacher in the given context, such as the teacher with respect to a course, topic, student, or group of students. Calculation of numerous indices for various students or student groups allows affinity mapping for the teacher. Student-teacher affinity determinations for individual teachers and individual students or groups of students allows the system to track trends, identify patterns, or the like.

### Matching (Analytics) Component

The systems herein employ a matching (also known as analytics) component, and the various methods employ the matching component in various functions. In embodiments the matching component is configured to automatically determine an intervention based at least on the teacher effectiveness index, the intervention suitable to assist the teacher and improve the teacher effectiveness index for the teacher. Further details regarding the intervention are provided herein.

In embodiments the matching component determines various effectiveness measures by analysing the students/teachers activity stream and longitudinal data based on the computational results of the measurement component.

The matching component, in embodiments, identifies teachers to support. For example, the component clusters teachers based on a variety of factors such as collaboration group, teaching strengths, weaknesses, effectiveness in teaching specific topics, students, or groups or students, and the like.

In embodiments, based on the various effectiveness and affinity measures described herein, the matching component connects or matches teachers with available online and offline resources. For example, based on the lesson plan and schedule of a teacher, the system enables sharing of lecture notes and assignments (from a digital library or from specific content sources) to the teacher dynamically and in real-time. Based on teacher queries, the system may further enable resources from a teacher network to be available online to the teacher during the classroom session.

The system (e.g., via the matching component) can identify one or more interventions based on the teacher effectiveness index and other relevant data for the context. Interventions take a variety of forms, including an action selected from revision of teaching content, revision of teaching strategy, adoption of a teaching activity, consultation with a mentor, digitally sharing a lesson plan, digitally sharing a teaching strategy, enrolment in a professional development course, revision of a teaching assignment, and invitation of a co-teacher, a suggested lesson plan received from a teacher network, and the like. The intervention can be paired with relevant supporting information, teaching effectiveness studies, example modifications, model teaching guides or tools, or the like. Such information can be obtained from a human resource on the teacher network (e.g., another teacher on the network) or from generalized sources such as digital libraries of teaching aids, the Internet, virtual teaching aids and virtual assistants, etc. The intervention can comprise a digital invitation to digitally interlink the teacher with a human resource such as a complementary teacher on the teacher network or another resource on the network.

The intervention is based in part on the teacher effectiveness index, but may also be based on analysing one or more of various contextual data. For example, contextual data may include the topic, content, grade level, student demographics, student group, and teacher strategy, the teacher profile and cohort, historical performance of the teacher, historical performance of students interacting with the teacher, and the like.

For each identified intervention (e.g., prescriptions or recommendations), the system guides teachers by selecting and instantiating appropriate intervention type from one or more intervention databases configured with the TSS. The system can include a recommendation component configured to recommend to teachers to enroll in support programs and activities for professional development. The support programs and activities for professional development are intervention types that are fetched from the intervention databases based on analysis results. As discussed herein, the system may further comprise a networking component configured for connecting Teachers to complimentary teaching and learning groups.

Using teacher effectiveness and student-teacher affinity measures (and other measures/data as described herein), and via the interventions that are proposed by the system, the system achieves or seeks to achieve, among other results, optimal assignment(s) of the teacher. By “optimal” in this context is meant that the teacher is most effectively able to teach material, and/or the student(s) is most effectively able to receive and process and learn such material. Such achievement is guided by the current teacher effectiveness index. Achievement or non-achievement of optimization can be determined for example by comparing various determined indices over time or across various contexts. The completion or progression (achieved or non-achieved) of the teacher on recommended material will be used to update the teacher effectiveness index.

### Teacher-Network Services Component

The systems herein further comprise a networking component (also referred to as a teacher-network services component or simply a services component) that, in embodiments, is configured to automatically identify a human resource based at least on the teacher effectiveness index. The various methods herein use the networking component for a variety of functions pertaining to linking a teacher with the identified human resource.

In embodiments, the human resource is one that is suitable to assist the teacher and improve the teacher effectiveness index for the teacher. For example, the human resource may be a mentor, a trainer, an expert, a second teacher (i.e., a peer teacher), a manager, a group, a mentoring group, a learning group, a support group, or another human resource, or a combination thereof. The human resource can provide substantive assistance in terms of teaching content, teaching assistance in terms of teaching style and delivery method, psychological assistance, or combinations thereof.

The human resource can be a part of a teacher network. The teacher network is a digital/virtual network comprising a variety of resources such as those described above, all interlinked via electronic communications and any of a variety of interfaces. The network can be a general-purpose network such as the Internet or can be a dedicated network specifically for the purpose of networking the teacher and the various resources available via the systems herein. Each human resource can be a node on the network or certain resources can be grouped to form a common node, and combinations of such architecture are also suitable. The network enables communications to be exchanged between the teacher and any of the human resources on the network—either individually or in combination (e.g., two resources at once, or more than two, including communication with all resources simultaneously). Such communications can be private and secured or can be public and unsecured. In embodiments, the communications involve a user interface such as a graphical user interface with text and images and/or an audio interface. The interactions between the teacher and the human resource can be carried out in real-time (i.e., live interaction) or otherwise (such as delayed communication via email or the like).

In an example, the networking component enables identification of an available expert or peer teacher in the network to connect online in runtime towards the required support for the teacher. The teacher may be directed to an expert teacher to share content on specific topic based on student's query, with such sharing carried out via the teacher network.

In embodiments the networking component identifies resources suitable for online and/or offline support of a teacher towards teaching strategy selection or content selection. Alternatively or in addition, the component identifies other teacher services from the network such as teaching plan recommendation, and teaching collaboration, or the like.

### Feedback and Control Component

The systems herein comprise a feedback component (also referred to as a feedback and control component) configured to automatically generate an output based at least on the determined teacher effectiveness index and the determined intervention. The methods described herein employ the feedback component to communicate an output (e.g., information such as resources, etc.) to the teacher, among other functions that are controlled by the component.

In embodiments, the output is configured to alter a user interface to identify to the teacher the intervention and, when present, an identified human resource. In embodiments, the output is automatically generated and formatted (e.g., by the server) as a message (e.g., a notification), the message at least comprising the intervention (or a component thereof) and configured for transmission across a distributed network to be received by a device such as a user device (e.g., a mobile phone or a computer used by a teacher). The message may further comprise, for example, identification data of the user, contact information for when the recipient requires help, or metadata such as time and location data.

The message is configured to alter a user interface on the user device upon receipt or at a predetermined time thereafter. The user interface can be on any suitable device such as a desktop computer, tablet, mobile phone, dumb terminal, augmented reality, dedicated device, or the like. In embodiments the user interface is located on a device disposed in a classroom where the teacher interacts with students, where data is collected, etc. The device may be fixed or mobile. The device may have an output component such as a display (touch screen or other type of display), audible output component, printer, or combinations thereof. The user interface will typically be incorporated with the output device and may allow for the teacher to interact with the system to carry out a variety of functions, such as retrieving test results, retrieving observation data or other data, accessing the teacher network, accessing human resources, accessing teaching resources, interacting with others on the teacher network (via voice and/or image) and the like. The device may further configure with external output device (e.g., an Amazon Echo or Google Home device and the like).

Depending on the content of an intervention, a user interface such as a GUI will be altered upon receipt of a message comprising the intervention. For example, the GUI may be altered to display an interactive menu inviting feedback from the teacher, displaying content of the intervention, enabling communication with a complementary teacher, mentor, or co-teacher, or the like. The intervention may instruct the user interface to gather more information, such as further sensor data, input from the teacher, or the like. In embodiments this may be automatically initiated—e.g., sensor data may be automatically (or semi-automatically) collected based on instructions from the intervention.

The intervention may further include a component that is transmitted separately to a network-enabled sensor, i.e., to the one or more sensors used to collect observation data. The message transmitted to the sensor may include instructions for further data collection, such as instructions configured to automatically cause the sensor to begin collecting data (e.g., at a subsequent meeting of the teacher's class).

In embodiments, upon reception of signals from the analytics component, the feedback component retrieves feedback from system-generated pools and updates a corresponding teacher-network graph. The feedback component may further send such information to individual teachers on the network.

The feedback component may comprise a feedback loop with a social networking platform on the teacher network, such that it is possible for one teacher to share insights disseminate teaching strategies, disseminate content, and share learning activities with other teachers on the network. The system may further enable sharing of links with guided lesson planners and/or a forum with a discussion facilitator.

The output and feedback loop may alternatively or in addition involve recording follow-up observation data of the teacher after delivering the intervention to the teacher and allowing the teacher time to implement the suggested activities, contact the relevant complementary teachers, etc. The follow-up observation data can allow the system to calculate a follow-up teacher effectiveness index, which is recorded and communicated to the teacher such that the teacher can track progress and improvement.

In an embodiment the feedback component customizes various applications to enable teachers perform various online and offline tasks guided by prescribed analytical insights.

The system is configured to communicate the message comprising the intervention to a user account corresponding to the teacher (i.e., the teacher that is the subject of the observation data resulting in the intervention) or to a group (i.e., plurality) of user accounts corresponding to a group to which the teacher is assigned. The systems herein can maintain a database of user accounts corresponding to a plurality of teachers inside and/or outside of the virtual teacher network. The user accounts comprise a destination identifier such as an email address or the like, as well as biographic, professional, and preference information about the user. Biographic information may comprise a name, identification number, age, gender, and other identification information. Professional information can comprise teaching expertise and history, qualifications, trainings, specializations, and the like. Preference information can include information submitted by the user such as preferred subjects, teaching styles, methodologies, age groups, and the like.

In embodiments, the teacher can be assigned to a group of teachers that share a characteristic (e.g., have similar or complementary teaching styles, have similar or complementary teaching interests, have similar or complementary teaching experience, have similar weaknesses, have similar teacher effectiveness indices, have similar backgrounds or training, or the like, or combinations thereof).

In embodiments the system comprises a feedback control component configured, upon reception of signals from one or more analytics engines (e.g., data analysis, statistical analysis, modelling engines, etc.), to retrieve feedbacks from system-generated pools (e.g., databases, sub-groupings of data or other components within the system, etc.) and to dynamically update one or more corresponding teacher-network graph. The teacher network graph provides, in embodiments, a digital representation of the inter-networking of the teachers (i.e., users) in the system.

### Methods of Use

The systems and methods described herein are suitable for a variety of methods of use, some of which are described herein and others of which will be apparent to one of ordinary skill in the art.

In embodiments, the systems and methods are suitable for estimating optimal teacher assignment per class and/or per subject using such student-teacher affinity measures and teacher effectiveness measures as described herein. For example, the system can carry out a maximal matching problem of the bipartite graph. For example, the system can be used for improved class level/school level outcome. For example, the system can be used for improved student engagement. In embodiments, the systems and methods are suitable for developing optimal assignment(s) of teachers to various improvement programs and other programs with a school, for improved school level outcome.

The systems may be used, based on the measures and methods described herein, to identify teachers that are most in need or otherwise in need of support or collaboration with other teachers or other human resources. The system may further be used to identify recommendations to be made to teachers in order for them to improve the measures.

In aspects are devices configured to carry out the methods described herein. The devices may comprise a processor and a memory coupled to the processor, the memory configured to store program instructions for instructing the processor to carry out the method. Further details are provided herein. It will be appreciated, however, that certain components of such devices, and further certain steps of the associated methods, may be omitted from this disclosure for the sake of brevity. The omitted components and steps, however, are merely those that are routinely used in the art and would be easily determined and implemented by those of ordinary skill in the art using nothing more than routine experimentation, the general state of the art, and the disclosure herein. Throughout this specification, where hardware is described, it will be assumed that the devices and methods employing such hardware are suitably equipped with necessary software (including any firmware) to ensure that the devices/methods are fit for the described purpose.

Various embodiments of the invention are described more fully hereinafter with reference to the accompanying drawings. The invention herein may be embodied in many different forms and should not be construed as limited to the embodiments set forth in the drawings; rather, these embodiments are provided to provide further illustrative non-limiting examples. Arrowheads in the figures are provided merely as examples of directions for the flow of data but are not exhaustive and are not meant to be limiting—i.e., data may flow (where appropriate) in directions that are not shown by arrowheads in the figures. Similar numbers in different figures are meant to refer to similar components.

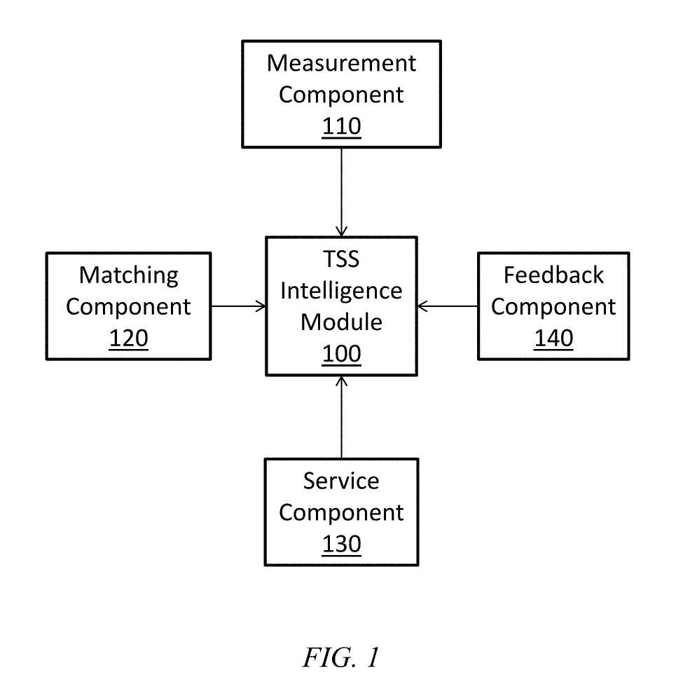

With reference to FIG. 1, there is shown an example architecture for the Teacher Support System (TSS) and components thereof according to an embodiment of the invention. In the schematic, the TSS is centered on the Intelligence Module 100, which module provides computational and logical functions. Intelligence Module 100 interacts with various modules/components that collectively form the TSS. For example Measurement Component 110 receives various data as described herein related to teacher effectiveness. Some of that data may include measurement data and performance data and may also include lesson plans, topical discussion roadmaps, and other content from the teacher directly or indirectly. Matching (analytics) component 120 may comprise a variety of algorithms such as a prescriptive analytics algorithm or a descriptive analytics algorithm (not shown). Service Component 130 provides teaching support applications and receives prescriptions from matching component 120 in order to assign/distribute appropriate applications. Feedback component 140 interfaces with a teacher network (not shown) and allows teachers to utilize the applications recommended/provided by service component 130.

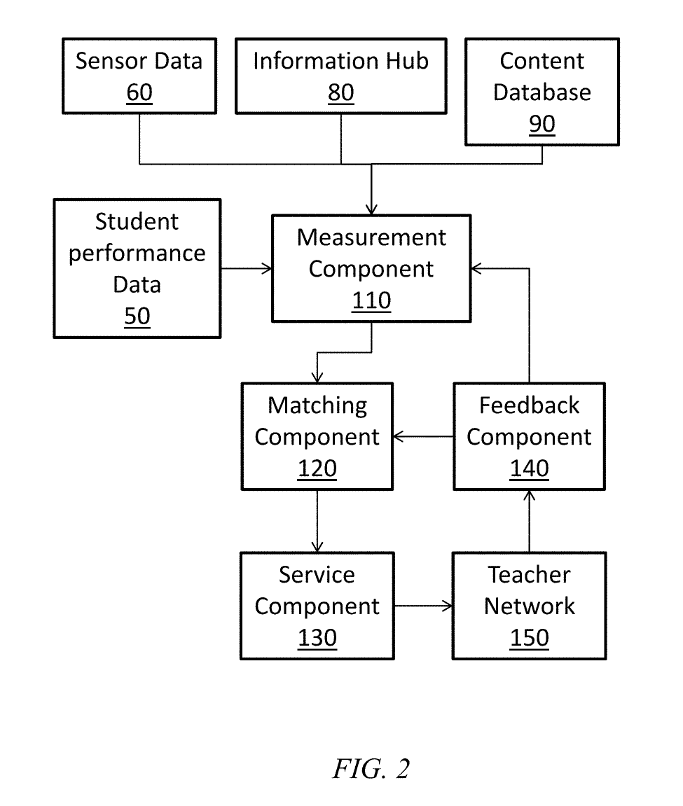

FIG. 2 provides an example flow chart for data and output from the TSS according to an embodiment of the invention. In addition to the components described in more detail in FIG. 1, the system in FIG. 2 also provides example architecture. Furthermore, measurement component 110 is shown receiving data from information hub 80 (which may, e.g., provide information on student-teacher relationships, student and/or teacher performance from the past or present, and the like), content database 90 (which may, e.g., provide various content related to teaching such as model curricula or teaching plans, teaching aids including visual and interactive aids, etc.), sensor data 60 (e.g., from one or more sensors such as cameras, microphones, etc., positioned to record interactions and actions of teachers and students in the classroom), and student performance data 50 (e.g., data from student devices such as tablets, indicating student comprehension of exercises/topics). Furthermore teacher network 150 is shown.

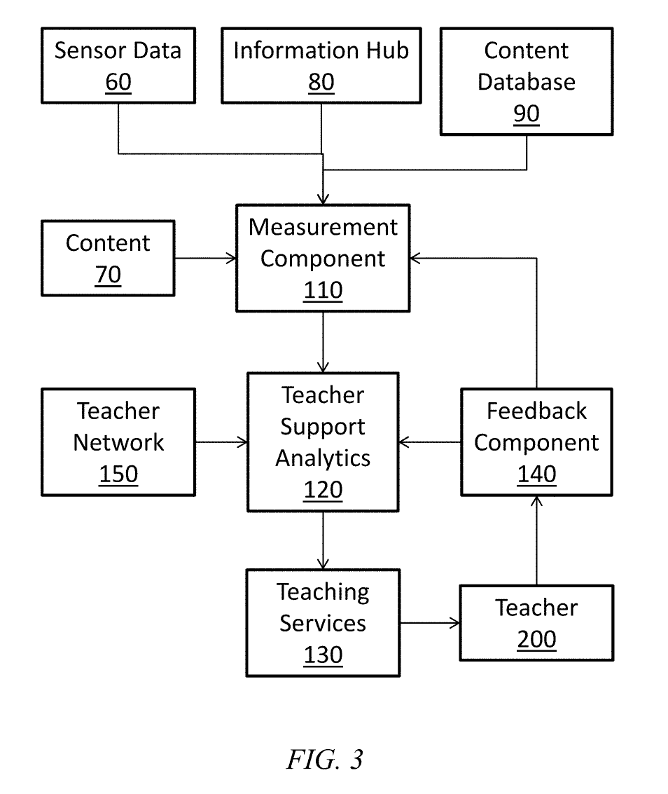

FIG. 3 provides an alternative example flow chart for data and output from the TSS according to an embodiment of the invention. In the figure, measurement component 110 further receives content 70 (which may be, e.g., specific content from a specific teacher rather than generalized information or content, including the teacher's specific lesson plan or other content) as well as sensor data 60 (e.g., from one or more sensors such as cameras, microphones, etc., positioned to record interactions and actions of teachers and students in the classroom). Teacher services module 130 interacts directly with teacher 200 (e.g., by providing applications directly to the teachers online account on the teacher network or elsewhere).

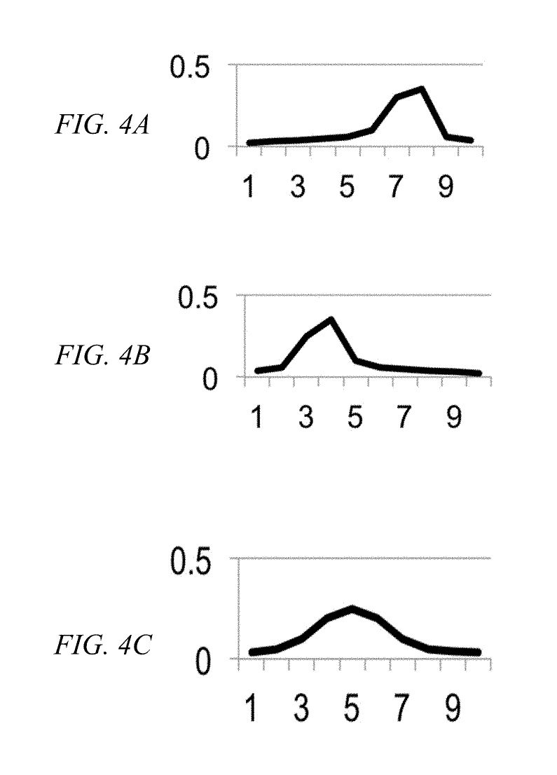

FIG. 4 provides schematic data showing effective teachers versus relatively ineffective teachers in a contextual setting for a specific topic or course. For each of the graphs in FIG. 4, the x-axis represents scores (higher scores represented by higher numbers) obtained on a specific assessment in a topic or course (e.g., an exam or the like), while the y-axis represents frequency. In the graph of FIG. 4C, an average historical score distribution is shown for a topic or course. In the graphs of FIGS. 4A and 4B, student performances are shown for a relatively effective teacher (in the graph of FIG. 4A) and a relatively ineffective teacher (in the graph of FIG. 4B). In embodiments, these sorts of metrics are obtained for a specific topic or course and for a variety of teachers in order to determine which of the teachers (or other factors such as demography, teaching style, etc.) are most effective.

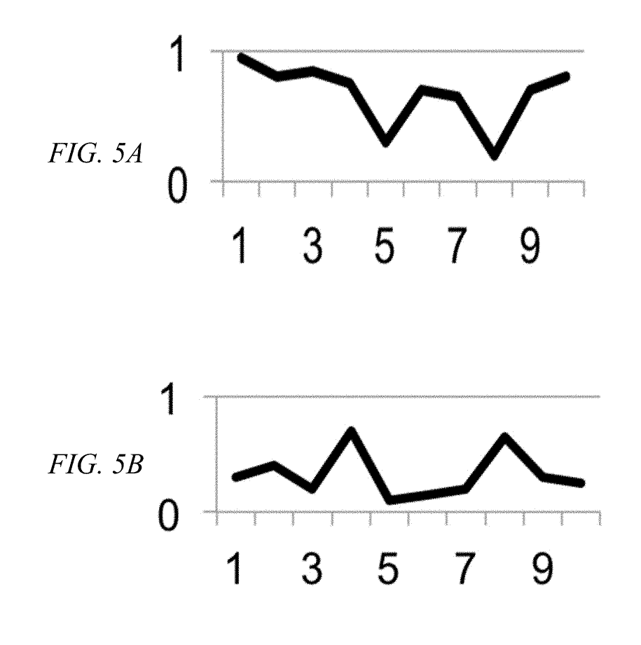

FIG. 5 provides schematic data showing effective teachers versus relatively ineffective teachers in a contextual setting across a variety of topics or courses. For each of the graphs in FIG. 5, the x-axis represents individual students, topics, or courses, while the y-axis represents performance. In the graph of FIG. 5A there is shown the graph for a specific teacher whom is most effective at the topics “1”, “2”, “3”, “4”, “6”, “7”, and“9”. In the graph of FIG. 5B there is shown the graph for a specific teacher whom is most effective at topics “4” and “8”. With such data, school administrators can efficiently assign teaching duties among a pool of teachers.

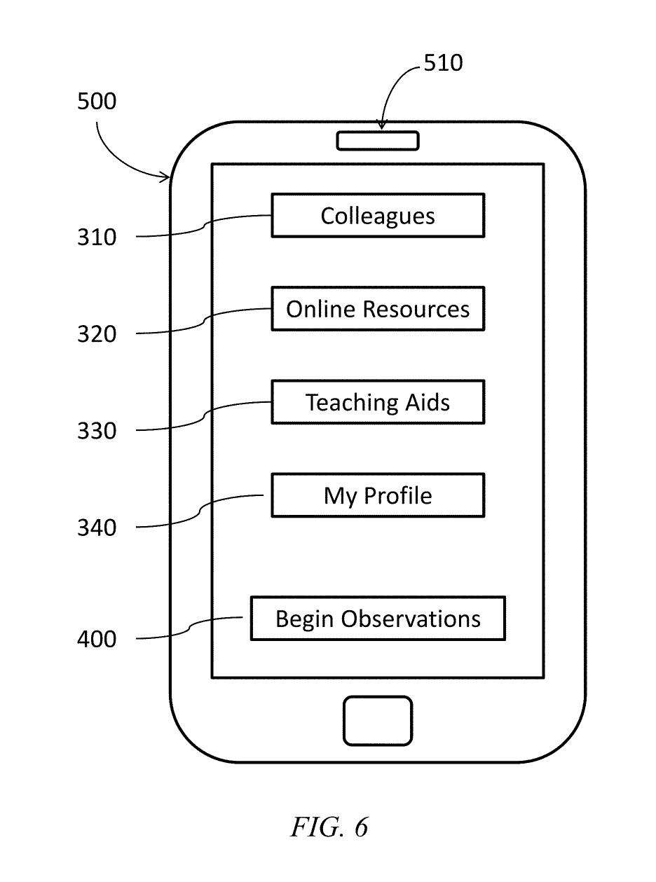

FIG. 6 provides an example screen of a graphical user interface (GUI) according to the invention. In the GUI shown, which may be a “home” screen in a user application for a mobile device belonging to a teacher, various buttons are provided. The Colleagues button 310 allows the user (i.e., teacher) to access a virtual network of colleagues, including personalized or generic sub-lists of the network such as selected mentors, complementary teachers, co-teachers, and the like. The Online Resources button 320 provides access to professional development courses, tutorials, example videos designed for training purposes, and the like. The Teaching Aids button 330 provides example/model syllabuses, exercises, and other resources that a teacher may find helpful in a specific context. The My Profile button 340 allows the user to access interventions and messages sent to their account, settings, and other personalized information. The Begin Observations button 400 allows the teacher to begin capturing observation data (e.g., using a sensor built into device 500, such as camera 510).

Throughout this disclosure, use of the term “server” is meant to include any computer system containing a processor and memory, and capable of containing or accessing computer instructions suitable for instructing the processor to carry out any desired steps. The server may be a traditional server, a desktop computer, a laptop, or in some cases and where appropriate, a tablet or mobile phone. The server may also be a virtual server, wherein the processor and memory are cloud-based.

The methods and devices described herein include a memory coupled to the processor. Herein, the memory is a computer-readable non-transitory storage medium or media, which may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Throughout this disclosure, use of the term “or” is inclusive and not exclusive, unless otherwise indicated expressly or by context. Therefore, herein, “A or B” means “A, B, or both,” unless expressly indicated otherwise or indicated otherwise by context. Moreover, “and” is both joint and several, unless otherwise indicated expressly or by context. Therefore, herein, “A and B” means “A and B, jointly or severally,” unless expressly indicated otherwise or indicated otherwise by context.

It is to be understood that while the invention has been described in conjunction with examples of specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. The pertinent parts of all publications mentioned herein are incorporated by reference. All combinations of the embodiments described herein are intended to be part of the invention, as if such combinations had been laboriously set forth in this disclosure.

What is claimed is:

1. A method for improving teacher efficiency, the method comprising:
recording observation data of a teacher using at least one sensor positioned to observe, in-situ, a student behavior and an interaction between the teacher and the student;
determining a teacher effectiveness index for the teacher in a context, the context comprising the observation data;
determining an intervention for the teacher suitable for improving the teacher effectiveness index for the teacher in the context, wherein the intervention is based at least in part on the determined teacher effectiveness index and the context, and wherein the intervention comprises at least one item selected from: an online identity corresponding to a complementary teacher in a virtual teacher network; an access enabler to an online teacher training software; and a digital teaching aid;
composing a message comprising the determined intervention, wherein the message is personalized to the teacher or is suitable for a teacher group to which the teacher is assigned; and
configuring a communication channel to deliver the composed message to a user account associated with the teacher or to a group of user accounts associated with the teacher group to which the teacher is assigned.

2. The method of claim 1, where after communicating the message, the method further comprises:
recording follow-up observation data of the teacher using the at least one sensor;
determining a follow-up teacher effectiveness index using the follow-up observation data; and
communicating, to the user account corresponding to the teacher, a message comprising the follow-up teacher effectiveness index.

3. The method of claim 1, wherein the context further comprises factors selected from topic, content, grade level, student demographics, student group, and teacher strategy.

4. The method of claim 1, wherein the teacher effectiveness index combines measures selected from student-teacher affinity measure, teacher-content effectiveness measure, content-teaching strategy effectiveness measure, topic-content effectiveness measure, and topic-teaching plan effectiveness measure.

5. The method of claim 1, wherein the teacher effectiveness index is further determined using data collected by one or more devices configured for use by a student.

6. The method of claim 1, wherein the teacher effectiveness index is determined by an algorithm, and wherein the algorithm is periodically updated based on analysis of pooled effectiveness data.

7. The method of claim 1, wherein:
the online identity enables the teacher to communicate with the complementary teacher using the virtual teacher network, wherein the complementary teacher is selected from a mentor teacher and a potential co-teacher;
the access enabler is a digital link or a passcode enabling the teacher to access the teacher training software; and
the digital teaching aid comprises: a recommendation for revision of a teaching strategy, teaching content, or lesson plan; a model lesson plan or model teaching strategy; a recommendation for adoption of a teaching activity; and a recommendation for enrollment in a professional development course.

8. The method of claim 1, wherein the communicating to the user account corresponding to the teacher comprises modifying a user interface on a device used by the teacher, electronically sending a message to user accounts corresponding to one or more complementary teachers, or modifying a user interface on a device used by a student, or a combination thereof.

9. The method of claim 1, further comprising aggregating teacher effectiveness indices from a plurality of teachers and optimizing teacher assignments based on the aggregated indices.

10. A system for improving teacher efficiency, the system comprising:
a sensor for recording observation data of a teacher using at least one sensor positioned to observe, in-situ, a student behavior and an interaction between the teacher and the student;
a measurement component configured to automatically estimate a teacher effectiveness index for the teacher in a context, the context comprising the observation data;
a matching component configured to automatically determine an intervention for the teacher suitable for improving the teacher effectiveness index for the teacher in the context, wherein the intervention is based at least in part on the determined teacher effectiveness index and the context, and wherein the intervention comprises at least one item selected from: an online identity corresponding to a complementary teacher in a virtual teacher network; an access enabler to an online teacher training software; and a digital teaching aid;
a communicating component configured to automatically communicate to the teacher a message comprising the determined intervention, wherein the message is personalized to the teacher or is suitable for a teacher group to which the teacher is assigned, by configuring a communication channel to deliver the composed message to a user account associated with the teacher or to a group of user accounts associated with the teacher group to which the teacher is assigned; and
a GUI component configured to automatically modify the display of a user device to display at least a portion of the intervention.

11. A teacher support system comprising:
at least one sensor positioned to observe, in-situ, observation data of a student behavior and an interaction between a teacher and the student, the at least one sensor configured to communicate the observation data via a distributed network; and
a server configured to receive the observation data via the distributed network, the server comprising:
a processor coupled to a memory;
a measurement component configured to automatically determine a teacher effectiveness index for a teacher in a context, the context comprising the observation data and, optionally, student performance data;
a matching component configured to automatically determine an intervention based at least on the teacher effectiveness index, the intervention suitable to assist the teacher and improve the teacher effectiveness index for the teacher;
a networking component configured to automatically identify a human resource based at least on the teacher effectiveness index, the human resource suitable to assist the teacher and improve the teacher effectiveness index for the teacher; and
a feedback component configured to automatically generate an output based at least on the teacher effectiveness index, the output configured to alter a user interface to identify to the teacher the intervention and the human resource.

12. The system of claim 11, further comprising a feedback control component configured, upon reception of signals from one or more analytics engines, to retrieve feedbacks from system-generated pools and to dynamically update one or more corresponding teacher-network graph.

13. The system of claim 11, wherein the teacher effectiveness index for the teacher is determined based on observation data selected from a teacher-student affinity measure, a teacher-content effectiveness measure, a teaching strategy content effectiveness measure, a topical content effective measure, and combinations thereof.

14. The system of claim 11, wherein the at least one sensor is selected from: a stand-alone sensor located in a classroom and positioned to monitor a student behavior and an interaction between the teacher and the student; a sensor disposed in an interactive device configured for use by the student; and combinations thereof.

15. The system of claim 11, wherein the intervention comprises an action selected from revision of teaching content, revision of teaching strategy, adoption of a teaching activity, consultation with a mentor, digitally sharing a lesson plan, digitally sharing a teaching strategy, enrolment in a professional development course, revision of a teaching assignment, and invitation of a co-teacher.

16. The system of claim 11, wherein the intervention comprises a suggested lesson plan received from a teacher network along with a suggested teaching strategy suitable for the lesson plan.

17. The system of claim 11, wherein the human resource is a complementary teacher in a virtual teacher network or a professional development specialist.

18. The system of claim 11, wherein the human resource can be a virtual assistance configured with interactive device and software program.

19. The system of claim 11, wherein the observation data are collected from a plurality of sensors, the plurality of sensors comprising at least a body camera and fixed point camera configured to observe a teacher-student interaction, and wherein the student performance data are collected by an application disposed on an interactive device selected from a tablet, desktop computer, and laptop computer.

20. A method for improving teacher efficiency, the method comprising:
automatically estimating a teacher effectiveness index based on:
observation data selected from: teacher—student affinity measure; teacher—content effectiveness measure; teaching strategy—content effectiveness measure; and topic—content effectiveness measure;
student/teacher data selected from: comparison with overall distribution of historical performance data; comparison with historical data with respect to group of student; comparison with historical data with respect to a single student; estimated teaching effectiveness towards a course or group of students; and estimated individual student-teacher affinity;
automatically communicating a recommendation to a teacher, the recommendation comprising: selected specific teaching content for a teacher to group of students; selected effective teaching strategies for topics/content for a group of students; selected teaching plan for topics/contents for teachers to group of students; and optimal assignment of teachers to classes/courses/training programs given constraints of limited classes, courses and training programs; and
automatically connecting the teacher to teacher resources in real-time or in offline mode.
